(19) United States
(12) Patent Application Publication
(10) Pub. No.: US 2013/0172071 A1
(43) Pub. Date: Jul. 4, 2013

(54) GAMING SYSTEM INCLUDING GAMING MACHINES WITH PAPER CURRENCY RECYCLERS

(71) Applicants: Elia Rocco Tarantino, Las Vegas, NV (US); Robert W. Nader, Schaumburg, IL (US)

(72) Inventors: Elia Rocco Tarantino, Las Vegas, NV (US); Robert W. Nader, Schaumburg, IL (US)

(21) Appl. No.: 13/523,147

(22) Filed: Jun. 14, 2012

Related U.S. Application Data
(60) Provisional application No. 61/498,325, filed on Jun. 17, 2011.

(51) Int. Cl. A63F 13/00

(52) U.S. Cl. CPC A63F 13/00
USPC 463/25

(57) ABSTRACT

A gaming machine is configured to accept paper currency from a player for use in placing wagers. The paper currency is accepted by a currency recycler which either stores the paper currency in a storage area or a dispensing area. Upon the gaming machine returning value to the paper, such as upon player cash-out, the recycler dispenses currency from the dispensing area. In one embodiment, a plurality of gaming machines communicate with a server which tracks accrued value at the gaming machines and controls the paper currency recyclers, including to change the amount of currency directed to storage versus dispensing area and/or the denomination of the currency routed to those areas.

### RELATED APPLICATION DATA

This application claims priority to U.S. Provisional Application Ser. No. 61/498,325, filed Jun. 17, 2011.

### FIELD OF THE INVENTION

The present invention relates to gaming machines which require an input of monetary or equivalents funds to present one or more games.

### BACKGROUND OF THE INVENTION

A variety of types of gaming machines which require monetary input to present one or more games are known. One type of gaming machine is an amusement gaming machine. Such a machine might present a video amusement game upon a player making a payment, such as $0.25. Such machines are known to offer a wide variety of games such as DONKEY KONG®, PAC-MAN® and others.

While these gaming machines must include payment handling apparatus, that apparatus is generally not very complicated. First, these machines generally require a small monetary payment, such as $0.25 (which may be paid with a single quarter-value coin). The monetary handling apparatus thus does not need to accept a variety of different coins, let alone coins and bills (paper currency). Second, the monetary payment made to these machines simply causes the machine to present one or more instances of an amusement game. These machines do not award prizes or pay winnings. Thus, the machines do not need to include monetary dispensing apparatus.

Wager based “casino” style gaming machines, however, are more complicated. In particular, these machines must accept monetary (or equivalent) funds, and also at one or more times may pay winnings in the form of monetary (or equivalent) funds.

Traditionally, slot-style casino gaming machines were configured to accept coins and to dispense coins. For example, a $0.25 slot machine would be configured to accept quarters. The quarters could be accepted through a coin slot and be deposited into a drop box (which box would be emptied from time to time). The slot machine would also include a coin payment apparatus, such as a coin box and dispenser. In the event of a winning game outcome, the monetary award would be paid to the player by dispensing coins from the dispenser to a coin tray from which the player could retrieve the coins.

This style of gaming machine was very common into even the 1990s and early 2000s, but it has a number of drawbacks. Among them is that such machines are maintenance intensive. Casinos much have personnel frequently service each and every machine in order to remove full coin accepting boxes and to insert or fill the separate coin box associated with the dispenser. The movement of coins into and out of the gaming machines requires the casino to pay significant labor costs, takes the gaming machine out of play while it is being serviced, and poses a risk of theft.

As one attempt to address this issue, “cashless” gaming machines were developed. These gaming machines are generally not truly cashless. Instead, most of these gaming machines are configured to accept bills (paper currency) and dispense tickets representing value rather than coins. This configuration has the advantage that accepting paper currency is more efficient than accepting coins. First, a bill acceptor may easily accept paper currency of different denominations, including denominations which are much higher in value than all currently circulated coins. Second, bills are smaller and easier to store as compared to coins which are large and heavy. Lastly, by issuing tickets having representative value, these gaming machines do not have to have complex coin dispensing apparatus and do not have to have such apparatus continually serviced. Instead, in the event of winnings or the player wishing to leave the gaming machine, the player is issued a ticket which represents the value of the unused player funds provided to the machine and any additional winnings. The player may then utilize such a ticket like paper currency at another machine (to provide that other machine with value for playing games) or may provide that ticket to a cashier to be exchanged into monetary funds.

However, even this gaming machine arrangement has a number of drawbacks. One problem is that the machines still accept paper currency and all of those accepted bills must be stored. Thus, from time to time the casino must service each gaming machine in order to replace a cash box which has been filled with accepted bills with another one that is empty. Again, this is labor intensive (and thus costly) and presents a security risk.

The presented invention overcomes these and other problems.

### SUMMARY OF THE INVENTION

One aspect of the invention comprises a gaming machine which includes a currency recycler which is configured to both accept paper currency or “bills” and dispense paper currency. Another aspect of the invention comprises a gaming system comprising two or more gaming machines having currency recyclers, the gaming machines being in communication with at least one server at one or more times.

In one embodiment, a gaming machine which is configured to present one or more wagering games includes at least one currency recycler. The gaming machine is configured to accept paper currency from a player for use in placing wagers. The paper currency is accepted by the currency recycler which either stores the paper currency in a storage area or a dispensing area. Upon the gaming machine returning value to the paper, such as upon player cash-out, the recycler dispenses currency from the dispensing area.

In one embodiment, a gaming machine may further comprise a receipt printer. Upon a player being paid value from the currency recycler, the receipt printer may dispense a receipt. The receipt may include information regarding the amount of value dispensed to the player, a remaining balance (such as a zero balance) remaining to the player at the gaming machine, or a remaining balance payable to the player, such as a fractional amount which was not paid by dispensing currency to said player.

In one embodiment, a plurality of gaming machines communicates with at least one server, such as an accounting server. The accounting server may track accrued value at each gaming machine. Such an accrued value may comprise a value of currency provided to the gaming machine by the player, less value wagered by the player, plus any value awarded to the player. The accounting server may also control the paper currency recyclers and/or receipt printers, such as to cause the currency recycler of a gaming machine to dispense currency and to cause the receipt printer to issue a receipt. In addition, at one or more times, the accounting server may cause a currency recycler to change the amount of currency directed to the storage area versus the dispensing area and/or change which currency is routed to the storage area versus the dispensing area based upon the denomination of the currency received by the currency recycler.

In one embodiment, each currency recycler includes a reader. The reader reads information from paper currency or other media input into the recycler. The currency recycler includes a validator or is configured to transmit read information to a remote validator, such as the accounting server. If currency is validated, it is accepted and, if not, it is rejected.

In one or more embodiments, the currency recycler and receipt printer may be controlled by a local gaming machine controller. The local gaming machine controller may, in turn, communicate with or be controlled by the at least one accounting server. In another embodiment, the currency recycler and/or printer may include their own controller which is directly controlled by the at least one server.

In a preferred embodiment, a gaming machine is only configured to receive value via a currency recycler (i.e. the gaming machine does not accept coins and does not include coin handling devices). In addition, the gaming machine also preferably does not include any coin dispensing apparatus. Advantageously, the recycler of the gaming machine permits the gaming machine to not only accept paper currency, but dispense accepted paper currency. In addition, via communication with a server, a gaming machine operator may advantageously remotely control the paper currency recyclers, such as to change how they manage accepted currency.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming system in accordance with one embodiment of the invention, the system comprising at least one gaming machine in communication with at least one server or other external device;

FIG. 2 is a diagram illustrating features of a gaming machine in accordance with an embodiment of the invention and the interfacing thereof with a server or other external device;

FIG. 3A is illustrates aspects of a gaming machine bill acceptor accepting a bill into a bill acceptor thereof; and

FIG. 3B illustrates the process of the bill acceptor dispensing one or more bills and issuing a cash-out ticket upon cash-out from a gaming machine.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a gaming system which includes at least one gaming machine having a currency recycler. Preferably, the gaming system further comprises at least one accounting server which is in communication with the at least one gaming machine at one or more times.

In accordance with one embodiment of the invention, a gaming machine is configured to only accept paper currency or “bills”. The paper currency is processed by a cash recycler wherein certain accepted bills are stored for removal from the gaming machine and others are temporarily stored for later dispensing from the gaming machine. In a preferred embodiment, the gaming machine communicates the value of accepted paper currency to an accounting server, along with wagers and wins, whereby the accounting server maintains a record of the current monetary value at the gaming machine. In the event a player wishes to cash-out of the gaming machine, the server causes the gaming machine to dispense currency to the player from the currency recycler, that currency representing the monetary value at the gaming machine. In addition, the server causes the gaming machine to also dispense a ticket or receipt which confirms that no funds remain on the gaming machine (or which represents any remaining fractional value of paper currency not dispensed to the player).

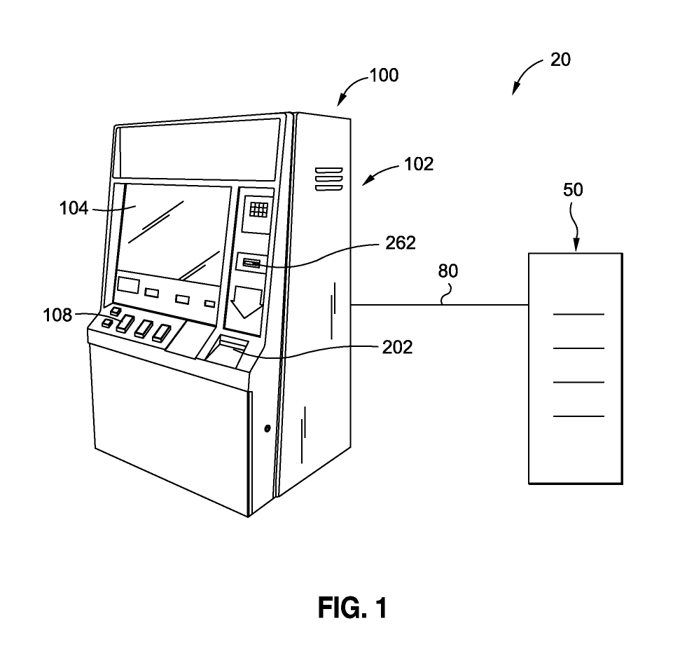

FIG. 1 illustrates one embodiment of a gaming system 20 in accordance with the invention. In one embodiment, a gaming system 20 comprises at least one gaming machine 100. Preferably, the gaming system 20 comprises a plurality of gaming machines 100. The system 100 might comprise two or more gaming machines 100, such as five (5) gaming machines 100.

In addition, the gaming system 20 includes one or more controlling devices. In a preferred embodiment, the gaming system 20 includes at least one server 50.

One embodiment of a gaming machine 100 is illustrated in FIG. 1. As illustrated, the gaming machine 100 generally comprises a housing or cabinet 102 for supporting and/or enclosing various components required for operation of the gaming machine. In the embodiment illustrated, the housing 102 includes a door located at a front thereof, the door capable of being moved between an open position which allows access to the interior, and a closed position in which access to the interior is generally prevented. The configuration of the gaming machine 100 may vary. In the embodiment illustrated, the gaming machine 100 has an “upright” configuration. However, the gaming machine 100 could have other configurations, shapes or dimensions (such as being of a “slant”-type or other configuration as is well known to those of skill in the art).

The gaming machine 100 preferably includes at least one display device 104 configured to display game information. The display device 104 may be a mechanical, electro-mechanical or electronic display, such as one or more rotating reels, a video display or the like. When the display device 104 is an electronic video display, it may comprise a cathode ray tube (CRT), high resolution flat panel liquid crystal display (LCD), projection LCD, plasma display, field emission display, digital micro-minor display (DMD), digital light processing display (DLP), LCD touchscreen, a light emitting display (LED) or other suitable displays now known or later developed, in a variety of resolutions, sizes and formats (e.g. 4:3, widescreen or the like). The display 104 may be capable of projecting or displaying a wide variety of information, including images, symbols and other indicia or information associated with game play, game promotion or other events.

As described in more detail below, the gaming machine 100 is preferably configured to present one or more games upon a player making a monetary payment or wager. In this regard, as described in more detail below, the gaming machine 100 includes means for accepting monetary value.

In one embodiment, certain game outcomes may be designated as winning outcomes. Prizes or awards may be provided for winning outcomes, such as monetary awards (or representations thereof, such as prize of credits), or promotional awards as detailed herein. As detailed below, the gaming machine 100 includes means for returning unused monetary funds and/or dispensing winnings to a player.

The gaming machine 100 may be configured to present a wide variety of games. Such games may comprise bingo or bingo-based games, pull-tab games, lotto or instant lottery style games, slot games, poker or other card games or a variety of other games.

The gaming machine 100 preferably includes one or more player input devices 108 (such as input buttons, plunger mechanisms, a touch-screen display, joystick, touch-pad or the like). These one or more devices 108 may be utilized by the player to facilitate game play, such as by providing input or instruction to the gaming machine 100. For example, such input devices 108 may be utilized by a player to place a wager, cause the gaming machine 100 to initiate a game (such as spin slot reels or display cards in a video poker game), to indicate cards to be held or discarded in a game of video draw poker, to “cash out” of the gaming machine, or to provide various other inputs.

In one preferred embodiment, the gaming machine 100 includes at least one microprocessor or controller for controlling the gaming machine, including receiving player input and sending output signals for controlling the various components of the machine 100 (such as generating game information for display by the display 104). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 104 (such as information representing images of displayed cards, slot reel symbols or the like), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 100 may also include one or more random number generators for generating random numbers, such as for use in selecting bingo numbers, cards, slot reel symbols or the like, for presenting the game in a random fashion.

The gaming machine 100 may be configured to generate and present games in a stand-alone manner or it may be in communication with one or more external devices at one or more times. For example, the gaming machine 100 may be configured as a server based device and obtain game code or game outcome information from a remote game server (in which event the gaming machine controller may receive game information from the server, such as game outcome information, and use that server-generated information to present the game at the gaming machine). In one embodiment, the gaming machines 100 may be game kiosks or interfaces. In other embodiments, two or more of the gaming machines 100 may be configured to permit different players to play the same game being offered via a common game server (such as the same bingo game).

It will be appreciated that the gaming machine illustrated in FIG. 1 is only exemplary of one embodiment of a gaming machine. For example, it is possible to for the gaming machine to have various other configurations, including different shapes and styles and having different components than as just described.

In one embodiment, the server 50 comprises at least one computing device. The server 50 may have, for example, at least one controller which is configured to execute various instructions (comprising executable software or embedded as hardware). In one embodiment, the server 50 includes or is coupled to a data storage device. Such might comprise one or more forms of semi-conductor type storage devices such as ROM or RAM (such as EEPROM, PROM, etc. as are now known or later developed), and or mass storage devices such as hard drives, tape drives or the like.

As described below, at one or more times the one or more gaming machines 100 are each in communication with the server 50. Thus, each gaming machine 100 and the server 50 preferably include at least one communication interface. Such an interface may comprise a combination of hardware and software. Each gaming machine 100 may communicate with the server 50 (and vice versa) via one or more communication links 80. Such links 80 may be temporary or permanent, may be wired or wireless or a combination thereof, and may include one more paths or components. For example, the links 80 might include portions of one or more LANs or WANs, including private or public networks. For security reasons, in a preferred embodiment the link 80 is a private communication link, such as an internal casino LAN. In order to secure exchanged information, the data may be protected, such as by encrypting it during its transmission over the communication link 80.

In one embodiment, as described in more detail below, the server 50 is configured to perform various accounting functions. For this reason, the server 50 is referred to herein as an “accounting” server. Of course, the server 50 might be referred to by other names and may be configured to perform various functions.

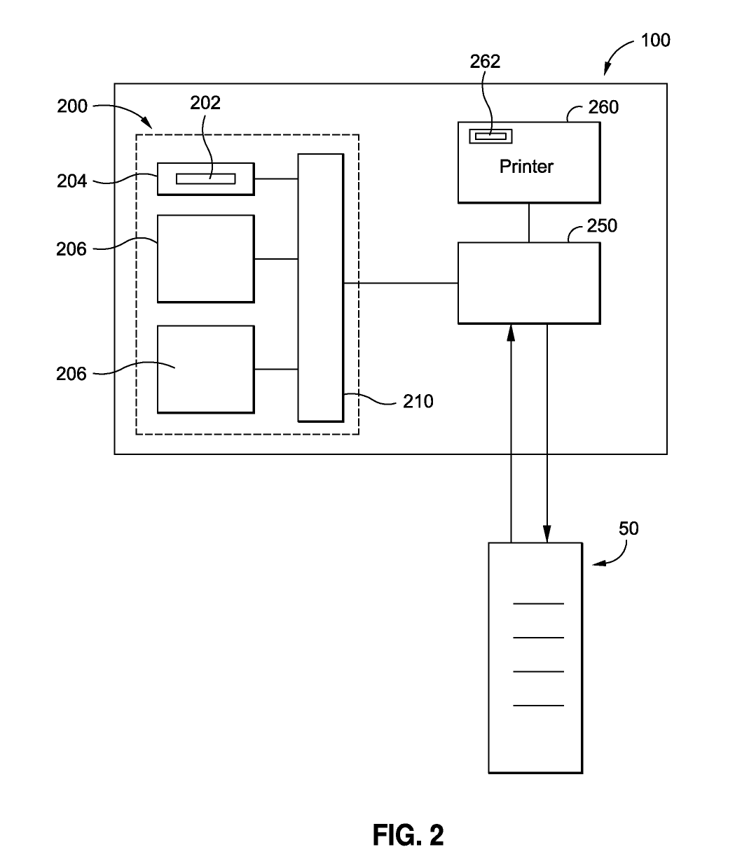

Additional details regarding the gaming system 20, including the gaming machines 100 and accounting server 50, will now be provided with reference to FIG. 2.

As indicated above, each gaming machine 100 is preferably configured to accept monetary or equivalent value from a player. In a preferred embodiment, the gaming machine 100 includes a paper currency or bill validating and recycling device 200, referred to herein as a “bill acceptor”.

In one embodiment, the bill acceptor 200 defines a bill accepting slot or opening 202. Preferably, this opening or slot 202 is accessible from the exterior of the gaming machine 100. For example, as illustrated in FIG. 1, the opening or slot 202 may be accessible from a front of the door of the gaming machine 100. Of course, the opening or slot 100 may have various other locations, including depending upon the location of the bill acceptor 200, as detailed below.

Preferably, the bill acceptor 200 includes a bill validator 204. The bill validator 204 is preferably configured to confirm the validity of a paper currency provided to the bill acceptor 200.

The bill validator 204 may have various configurations. In one embodiment, the bill validator 204 comprises a reader configured to scan, read or otherwise obtain information from a bill or other media which is inserted into it. The validator 204 may either include hardware and/or software for analyzing that information, or be configured to transmit that information to a remote location (such as to the accounting server 50) to be analyzed. The information is preferably analyzed to determine the validity of paper currency inserted into the slot 202 and, in one or more embodiments, the value of that paper currency, as is known. Of course, the validator 204 may be configured to reject any item which it cannot confirm as being valid paper currency. In this regard, the validator 204 may include one or more transport mechanisms for either pulling or moving a bill inserted into the bill acceptor 200 through the slot 202 and into the bill acceptor 200, or for ejecting an object (rejected bill or other object) back out of the slot 202.

In the event that paper currency input to the validator 204 is validated, the currency is preferably transported to a bill storage area. In a preferred embodiment of the invention, the bill acceptor 200 is configured to not only store bills, but dispense bills. Of course, this may be accomplished in various manners.

In one embodiment, the bill acceptor 200 includes both a temporary or dispensing box 206 and a storage box 208. Preferably, bills which are accepted by the validator 204 may be delivered to either the dispensing box 206 or the storage box 208, depending upon certain criteria. Of course, various transport mechanisms may be utilized for moving the bills from the validator 204 to those locations.

The dispensing box 206 and storage box 208 each comprise an area in which bills are stored. In a preferred embodiment, they comprise different areas, such as defined by different structures. The storage box 208 is preferably removable from the bill acceptor 200. In this manner, once the storage box 208 is full of stored bills, it can be removed from the gaming machine 100 and replaced with an empty storage box 208.

In a preferred embodiment, the bill acceptor 200 includes one or more transport mechanisms which permit bills to be dispensed from the dispensing box 206. Preferably, such mechanisms (which may be the same as or include the transport mechanisms for transporting bills through the bill validator 204 and/or for transporting the bills from the validator 204 to the dispensing box 206) are configured to move one or more bills which are located in the dispensing box 206 out of the bill acceptor 200 through the slot 202.

In one embodiment, the bill acceptor 200 comprises one or more controllers 210. The at least one controller 210 may be configured to control the various mechanisms of the bill acceptor 200. The bill acceptor 200 may include an illuminated bezel (not shown) which surrounds the bill slot 202. The color or other aspect of illumination may change depending upon the status of the bill acceptor 200. The controller 210 may control these one or more light features (such as to cause the light to illuminate green when the bill acceptor 200 is operating normally and has validated a bill to red when the bill acceptor 200 is malfunctioning or has rejected a bill). The controller 210 may also perform bill validation and/or transmit such information from the validator 204 to a remote device (such as the accounting server 50). The controller 210 may also control the transport mechanisms to accept bills and/or dispense bills.

The controller 210 of the bill acceptor 200 is preferably in communication with a gaming machine controller 250 of the gaming machine 100. As indicated above, the controller 250 of the gaming machine 100 may perform various functions, including generating game information for display by the display device 104 of the gaming machine 100 (see FIG. 1).

When a bill is accepted by the bill acceptor 200, information regarding the accepted bill is preferably transmitted from the bill acceptor 200 to the gaming machine controller 250. For example, the bill acceptor controller 210 may transmit information to the gaming machine controller 250 regarding the value of the bill accepted by the bill acceptor 200.

In one embodiment, the gaming machine controller 250 then indicates to the player of the gaming machine, such as via a display thereof, the value of the accepted bill. This may be indicated, for example, by displaying the number of credits associated with the gaming machine (wherein each credit has a representative value and the total number of credits is increased by the value of the accepted bill; for example, if the machine indicates credits each having a value of $0.25 and the player inserts a $10.00 bill, the machine would indicate 40 credits).

As also indicated above, the gaming machine 100 is configured to dispense the value to the player. In an embodiment where the gaming machine 100 maintains a credit balance of funds which have been deposited to the gaming machine by the player, less any credits wagered by the player, plus any credits won by the player, the player may “cash-out” those credits.

As described below, in one embodiment when a player wishes to cash-out, the gaming machine 100 is configured to dispense bills to the player representing the balance of credits. These bills are preferably dispensed by the bill acceptor 200 by having bills transported from the dispensing box 206 to the bill slot 202.

In addition, as also described below, the gaming machine 100 is also preferably configured to issue or dispense to the player a ticket or receipt. In this regard, in one embodiment the gaming machine 100 includes a ticket/receipt generator or printer 260. The ticket or receipt printer 260 may be configured to print information onto a paper media or substrate and then dispense that ticket, such as through a dispensing slot 262, to the player (as illustrated in FIG. 1, that slot 262 may be accessible at the door of the gaming machine 100, though it could be located elsewhere). The information printed on the ticket may vary, but preferably comprises transaction information, as detailed below. The transaction information may include information regarding an existing credit balance belonging to the player, the amount of bills issued to the player in cash-out of those credits, and the remaining zero ($0.00) balance (or if there is a remaining balance, such as a fractional value of a bill, the remaining value belonging to the player). The information may have various forms, such as text, numbers or codes such as barcodes. The information may be conveyed directly or one or more codes may be used which identify associated information in another location, such as stored in one or more remote data files.

The ticket printer 260 may have various configurations. For example, the ticket printer 260 may have a housing which holds a printer and a controller. In a preferred embodiment, the controller of the ticket printer 260 is in communication with the gaming machine controller 250. In this manner, the gaming machine controller 250 can transmit control instructions to the ticket printer 260.

As also described above, the gaming machine 100 is in communication with the accounting server 50 at one or more times. In one embodiment, the communication link may be between the gaming machine controller 250 and the server 50. In other embodiments, however, it is possible for the components of the gaming machine 100, such as the bill acceptor 200, to communicate directly with the server 50.

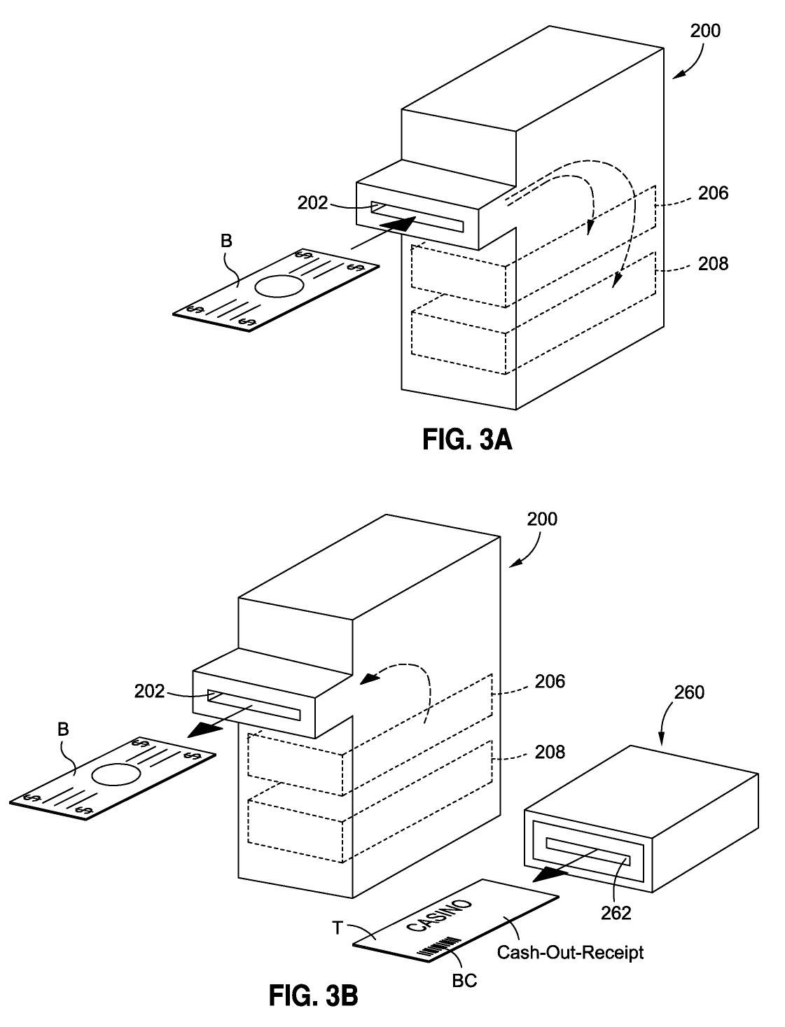

Various aspects of the operation of a gaming system 20 in accordance with an embodiment of the invention will now be described, primarily in conjunction with FIGS. 3A and 3B.

As illustrated in FIG. 3B, in a preferred embodiment of the invention, a player may only provide value to the gaming machine 100 by tendering one or more bills B of monetary value to the gaming machine. For example, the player may be permitted to tender U.S. currency in the form of $1.00, $5.00, $10.00, $20.00, $50.00 and/or $100.00 bills.

The player inserts the bills into the slot 202 of the bill acceptor 200. Each bill is validated, such as in the manner described above. If the bill is not approved, it is rejected and preferably dispensed back out of the slot 202 to the player. If the bill is approved, it is preferably routed to either the dispensing box 206 or storage box 208.

As indicated above, if the bill is accepted, the value thereof is preferably recognized by the gaming machine 100. For example, the gaming machine controller 250 may increase a credit balance by the value of the accepted bill.

In one embodiment, information regarding accepted bills and the credit balance belonging to the player is provided to the accounting server 50. For example, upon increasing a credit balance as a result of an accepted bill or bills, increasing a credit balance based upon a game win or decreasing a credit balance based upon a player's wager, the gaming machine controller 250 may send credit update information to the accounting server 50. In this manner, the accounting server 50 may maintain a duplicate record of such information. In the case where the gaming system 20 includes multiple gaming machines 100, this allows the accounting server 50 to comprise a single source for information regarding value activities at all gaming machines, including individual value transactions (accepted currency, individual wagers and individual game win awards), plus information regarding existing total accrued value to the player (the value of currency accepted, less amounts wagered, plus amounts won).

In addition, the accounting server 50 may be configured to generate aggregate or store credit information for multiple gaming machines, such as the total value of bills received by those machines during a period of time, the total amount of winnings paid or the total amounts wagered. Such information may be provided to the user of the accounting server 50 in the form of one or more reports. Such reports or other information might be displayed by one or more video or other displays associated with the accounting server 50, or such information might be printed.

The reporting of credit information from the gaming machines 100 to the accounting server 50 has numerous other advantages. For example, such information may be used for audit purposes. The information may also be used in the event of data corruption or the like at an individual gaming machine 100, such as to replace that corrupted data.

As indicated above, a player may be permitted to wager one or more credits to play games. In addition, the games may award winnings for one or more outcomes of those games. The winnings may be paid as one or more credits (i.e. causing an increase in the credit balance of the player at the gaming machine).

At one or more points in time, a player may wish to stop playing the gaming machine 100. At that time, the player may desired to “cash out”, or to remove the monetary value represented by the player's credit balance at the gaming machine. Such may be initiated by the player pressing a “cash out” button at the gaming machine 100 (or by other designated input).

In one embodiment, if a player requests to cash out, the gaming machine controller 250 provides such an indication to the accounting server 50. The accounting server 50 preferably checks the credit balance of the player at the gaming machine. This balance may be reconciled with a balance indicated by the gaming machine.

The accounting server 50 may then send instructions to the gaming machine controller 250 to effect payment to the player. In one embodiment, this may comprise instructions which cause the gaming machine controller 250 to cause the bill acceptor 200 to issue bills B to the player in an amount equal to the player's credit balance, as illustrated in FIG. 3B. Upon such a signal, the controller 210 of the bill acceptor 200 may cause bills to be dispensed from the dispensing box 206 through the bill slot. For example, if the player has a balance of 100 credits each having a value of $1.00, then the bill acceptor 200 preferably issues to the player bills having a value of $100.00. This might comprise, for example, a single $100.00 bill or five (5) $20.00 bills. Once payment has been made to the player, the player's credit or value balance is preferably zeroed or cleared, such as at the gaming controller 250 and/or the server 50.

Preferably, the gaming machine 100 also issues a cash out confirmation ticket T to the player. In one embodiment, information regarding such a ticket may be generated by the accounting server 50. This information may be transmitted to the gaming machine controller 250. The gaming machine controller 250 may then cause the ticket printer 260 to print and dispense a ticket to the player.

In the event that the one or more bills B dispensed to the player represent the full amount of the payment to the player, then the ticket T may represent or indicate a remaining value of $0.00 owed to the player. The ticket might also confirm the value of the cash out and the time of the cash out. For example, if a player cashes out $100.00 worth of credits and is paid $100.00, the ticket may indicate a gaming machine identifier, the time of the cash out, payment to the player of $100.00 in bills, and a remaining value of $0.00 owed to the player. In this manner, the ticket may represent a receipt for the player.

In the event the player can not be paid in bills, then the ticket may also represent any remaining value. For example, the gaming machine 100 might maintain a balance of credits each having a value of $0.25. As a result, a player might have a credit balance after a period of game play of $40.50. The player might be paid $40.00 at cash out in the form of two (2) $20.00 bills. However, the remaining $0.50 balance can not be paid with a bill when the smallest bill value is $1.00. As a result, the ticket issued to the player might indicate a remaining value of $0.50.

In one embodiment, various of such information may be printed directly on the ticket. In other embodiments, some information might be presented by one or more codes, such as a bar BC code, which is printed on the ticket T. Various information on the ticket, such as a bar code, may identify a file or the like at which detailed ticket information is stored.

For example, when a player indicates a desire to cash out, the accounting server 50 may generate a file. This file may be identified with a particular code. Information regarding the ticket may be stored in the file. Such information may comprise the gaming machine identifier, cash out time, cash out payment and, if the ticket has a value, the value of the ticket.

In one embodiment, a player who is issued a ticket having a value may be permitted to cash that ticket out (such as exchange it for currency such as coins or bills) at a location other than the gaming machine 100. For example, a player having a ticket with a $0.50 balance may cash that ticket out at a separate cashier station or the like (which station is configured to pay other than bills, such as coins). In such event, the cashier station or the like may read information from the ticket to obtain the value of the ticket and pay the player. For example, a bar code reader at a cashier station may be used to read a bar code printed on the ticket. The cashier station may utilize the bar code to either determine the value of the ticket directly and/or obtain the information from the accounting server 50 (such as by transmitting the ticket code to the accounting server 50 and the accounting server 50 using that code to access the corresponding data file for that ticket). Of course, upon payment of the ticket, the data file or other information regarding the ticket is preferably updated to indicate that the ticket has been paid (including to prevent the ticket from being re-presented).

The invention may have various configurations. As indicated, in one embodiment, the one or more servers 50 may communicate or control the currency recyclers and the ticket/receipt printers via the gaming machine controllers 250. In other embodiments, the one or more servers 50 might communicate with the currency recyclers and/or the ticket/receipt printers directly.

In one embodiment, value transactions associated with a gaming machine 100 (including accrued value) may be tracked by either the gaming controller 250 of the gaming machine and/or the one or more servers 50. In a preferred embodiment, the value transactions are tracked by both devices. For example, the gaming machine controller 250 retains information regarding a number of accrued value, such as credits, as does the server 50. In this manner, the information is duplicated for security and back-up purposes.

This configuration of a gaming system has various advantages and benefits. One advantage to the system is that gaming machines only accept bills. This eliminates the need for gaming machines to include costly coin handling apparatus. In addition, by using a bill acceptor which is capable of not only storing bills but dispensing them, less maintenance must be performed in order to either removed filled currency boxes (since in the present invention many accepted bills are re-dispensed, thus reducing the rate at which accepted bills must be stored and removed from the machine), or to provided filled currency boxes for payments (since in the present invention bills accepted by the machine can be re-dispensed).

Another advantage of the invention is the interface of the gaming machines with the accounting server and the ability of the accounting server to not only control the gaming machines but also obtain gaming machine accounting information.

As indicated, as one aspect of the invention a bill acceptor of a gaming machine may be configured to either store an accepted bill for removal from the machine or store it for re-dispensing. It may be advantageous to change the number of bills which are stored for removal versus re-dispensing, including changing the type of bills. As one example, during weekday play of the gaming machine, the rate of play may be slower and thus it may be desirable to maintain a low currency balance in the dispensing box and/or smaller denominations of bills. On the other hand, during weekend play, the rate of play may be higher and thus it may be desirable to maintain a higher currency balance in the dispensing box and/or larger denominations of bills.

In one embodiment, this feature may be controlled via the accounting server 50. For example, an operator may program the accounting server 50 to send instructions to all of the gaming machines 100 at 8:00 a.m. on a Friday morning to increase the value of bills held in the currency dispenser to a maximum value (such as by causing the bill acceptor 200 to route more bills to the dispensing box rather than the storage box), including by maintaining a higher count of $100.00 bills vs. $20.00 or $10.00 bills (by causing $100.00 bills to be routed to the dispensing box and lower denomination bills, such as $20.00 to be routed to the storage box). On Monday morning, the accounting server 50 may instruct the gaming machines 100 to reduce the value of bills held in the dispensing box (such as by routing incoming bills from players to the storage box of the bill acceptor) and/or to reduce the denomination of bills in the dispensing box (such as by routing larger denomination bills such as $100.00 bills to the storage box for removal and routing smaller denomination bills such as $20.00 to the dispensing box).

As one aspect of the invention, a gaming machine 100 may break bills. For example, a particular jurisdiction may limit the amount of money a player may put on a machine to $20. A player may only have, however, a $100.00 bill. In accordance with the gaming machine of the present invention, the player may insert the $100.00 bill and the gaming machine may credit $20.00 to the gaming machine and then re-dispense $80.00 in change to the player. This is accomplished by dispensing the $80.00 from the bill acceptor.

Of course, the gaming system and gaming machine of the invention may have other features and configurations. As one example, the gaming system may include other servers or devices. For example, the gaming system may include a player tracking server for tracking individual player play (such as by one or more identification cards which identify the player and which are read by the gaming machine). The gaming system might also include a progressive server or the like.

In a preferred embodiment, the bill acceptor comprises a paper currency recycler which has two bill storage areas. However, it is possible to utilize a paper currency recycler having a single bill storage area (to which bills are sent for storage and from which bills are dispensed), and it is possible to utilize a paper currency recycler having more than two storage areas

In addition, while the paper currency recycler may be configured to accept different denominations of paper currency, it might be configured to accept only one denomination. In other embodiments, the currency recycler might also be configured to segregate different denominations of bills (such as by routing accepted $100.00 bills to the storage box and routing $20.00 to the dispensing box).

The term paper currency has been used herein. Such currency need not comprise paper, as is well known in the art. Preferably, however, the paper currency or bills do not comprise coins or other heavy metallic objects, but instead preferably comprise light weight, planar printed materials or media. Most preferably, that media comprises a currency, namely media issued by a governmental entity which comprises a recognized form of payment.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a housing;
at least one game information display device supported by said housing;
at least one player input device supported by said housing;
a game controller configured to cause said gaming machine to present one or more wagering games, receive input from said at least one player input device relative to the initiation or play of a wagering game, and to cause said at least one game information display device to display wagering game information at one or more times;
a paper currency recycler configured to accept paper currency for use by a player in placing a wager to play a wagering game, store one or more paper currency in a first storage area for later removal from said gaming machine, store one or more paper currency in a dispensing area, and at one or more times dispense paper currency from said dispensing area; and
a printer configured to issue one or more receipts comprising printed media;
wherein said gaming machine is configured to only accept paper currency as the form of value from which a player may place wagers, and wherein when an accrued value at said gaming machine is to be dispensed to said player, said paper currency recycler dispenses currency from said dispensing area and said printer issues a receipt reflecting a zero balance or any remaining value not paid by said paper currency recycler.

2. The gaming machine in accordance with claim 1 wherein said paper currency recycler further comprises a validator configured to validate a paper currency provided to said paper currency recycler and configured to accept validated paper currency and configured to reject non-validated paper currency.

3. The gaming machine in accordance with claim 1 wherein said first storage area comprises a cash box which may be removed from said paper currency recycler.

4. The gaming machine in accordance with claim 1 wherein said gaming machine is configured to dispense said accrued value when a player provides a cash out input to said gaming machine.

5. The gaming machine in accordance with claim 1 wherein said accrued value comprises a value of any paper currency provided by said player to said gaming machine, less any value wagered by said player, plus any value awarded to said player as a result of wagering game play.

6. A gaming system comprising:
at least two gaming machines, each gaming machine comprising:
a housing;
at least one game information display device supported by said housing;
at least one player input device supported by said housing;
a game controller configured to cause said gaming machine to present one or more wagering games, receive input from said at least one player input device relative to the initiation or play of a wagering game, and to cause said at least one game information display device to display wagering game information at one or more times;
a paper currency recycler configured to accept paper currency for use by a player in placing a wager to play a wagering game, store one or more paper currency in a first storage area for later removal from said gaming machine, store one or more paper currency in a dispensing area, and at one or more times dispense paper currency from said dispensing area; and
a server in communication with said at least two gaming machines, said server configured to track an accrued value at each gaming machine and, at one or more times, to cause said accrued value associated with a gaming machine to be paid to a player by causing said paper currency recycler of said gaming machine to dispense paper currency to said player of said gaming machine.

7. The gaming system in accordance with claim 6 wherein said server is configured to control said paper currency recycler of each gaming machine to change a number of paper currency each paper currency recycler stores in said dispensing area or said storage area.

8. The gaming system in accordance with claim 6 wherein said server is configured to control said paper currency recycler of each gaming machine to route paper currency to said storage area versus said dispensing area based upon a denomination of said paper currency accepted at said paper currency recycler.

9. The gaming system in accordance with claim 6 wherein each gaming machine further comprises a receipt printer and said server is configured to cause said receipt printer of a gaming machine to print a receipt upon a player being paid an accrued value from said paper currency recycler of said gaming machine.
